(19) United States
(12) Patent Application Publication
(10) Pub. No.: US 2010/0235311 A1
(43) Pub. Date: Sep. 16, 2010

(54) QUESTION AND ANSWER SEARCH

(75) Inventors: Yunbo Cao, Beijing (CN); Chin-Yew Lin, Beijing (CN); Bo Wang, Beijing (CN)

Correspondence Address: John C. Meline;Lee & Hayes, PLLC, Suite 1400, 601 W. Riverside Avenue, Spokane, WA, 99201, US

(73) Assignee: Microsoft Corporation, Redmond, WA (US)

(21) Appl. No.: 12/403,560

(22) Filed: Mar. 13, 2009

(51) Int. Cl. G06N 5/02; G06F 17/30

(52) U.S. Cl. 706/46; 707/E17.108

(57) ABSTRACT

Exemplary methods, computer-readable media, and systems are presented for leveraging question-answering knowledge from community sites by complementing product search services with a search of questions, answers, reviews and other Internet accessible content including user-generated content. Product or service information is obtained by crawling Internet-accessible Web sites including community sites. An integrated index of such information is generated. A user is able to browse questions by product or service feature, by topic, by identified comparative questions, and by question ranking (for example, interestingness or popularity).

### BACKGROUND

Prior to making purchases, consumers and others often conduct research, read reviews and search for best prices for products and services. Information about products and services can be found at a variety of types of Internet-accessible Web sites including community sites. Such information is abundant. Product developers, vendors, users and reviewers, among others, submit information to a variety of such sites. Some sites allow users to post opinions about products and services. Some sites also allow users to interact with each other by posting questions and receiving answers to their questions from other users.

Ordinary search services yield thousands and even millions of results for any given product or service. A search of a community site often yields far too many hits with little filtering. Results of a search of a community site are typically presented one at a time and in reverse chronological order merely based on the presence of search terms.

A search of typical question and answer community sites typically results in a listing of questions. For example, a search for a product such as a “Mokia L99” cellular telephone could yield hundreds of results. Only a few results would be viewed by a typical user from such a search. Each entry on a user interface to a search result could be made up of part or all of a question, all or part of an answer to the corresponding question and other miscellaneous information such as a user name of each user who submitted each respective question or answer. Other information presented would include when the question was presented and how many answers were received for a particular question. Each entry listed as a result of a search could be presented as a link so that a user could access a full set of information about a particular question or answer matching a search query. A user would have to follow each hyperlink to view the entire entry to attempt to find useful information.

Such searching of products and services is time-consuming and is often not productive because search queries yield either too much information, not enough information, or just too much random information. Such searching also typically fails to lead a user to the most useful entries on community and other sites because there is little or no automatic parsing or filtering of the information—just a dump of entries matching one or more of desired search terms. Users would have to click through page after page and link after link with the result of spending excessive amounts of time looking for the most useful information responsive to a relatively simple inquiry.

To further compound the problem, product and service information is spread over a myriad of sites and is presented in many different formats.

### SUMMARY

This Summary is provided to introduce a selection of concepts in a simplified form that are further described below in the Detailed Description. This Summary is not intended to identify key or essential features of the claimed subject matter, nor is it intended to be used to limit the scope of the claimed subject matter.

Information from question-answer community sites is combined with an indexing search service. Community and other Internet-accessible Web sites are crawled and information such as questions and answers are extracted from these sites. An integrated index is built from extracted information. The integrated index is used in conjunction with a search service and other information through an improved user interface to provide an enhanced searching service to users.

To help users browse questions and answers efficiently, several features are provided. Each type of product or service is associated with a set of product or service features. In a search of community and other types of Web sites, questions, answers, and other types of information are grouped by feature. For example, questions are grouped around types of question. Sequential pattern mining, point of sale (POS) tags-based filtering, and other techniques are used to filter and group questions and other types of information. Grouping is also done by static ranking according to user interest or user-ranked input such as, for example, a tag of “interestingness.” For those bits of information that have not received a tag from a user, but likely would have been tagged by the user, a computer model automatically identifies and generates a user tag for such bits of information.

### BRIEF DESCRIPTION OF THE DRAWINGS

The Detailed Description is set forth and the teachings are described with reference to the accompanying figures. In the figures, the left-most digit(s) of a reference number identifies the figure in which the reference number first appears. The use of the same reference numbers in different figures indicates similar or identical items.

FIG. 1 is an exemplary user interface showing exemplary results of a product or service information indexing and search.

FIG. 2 shows an overview of the topology of the system described herein.

FIG. 3 is a diagram showing parts of a product or service information indexing and search.

FIG. 4 is flow chart showing a process for a product or service information indexing and search.

### DETAILED DESCRIPTION

This disclosure is directed to finding, sorting, indexing and presenting information about products and services to users. Herein, while reference may be made to a product, a service or something else may just as easily be the subject of the features described herein. For the sake of brevity and clarity, not limitation, reference is made to a product.

Previously, a user interested in a product would have had to use a search engine or other search tool to find product prices and would separately have had to search and then individually browse community sites, or at least individual entries from community sites, for reviews and other information. Community sites as understood herein include community-based question submission and question answering sites, and various forum sites, among others. Community sites as used herein include community question and answer (community QnA) sites.

One problem has been that valuable information buried in question and answer sites is not readily accessible when a user wishes to research a product. Another problem is that what is considered interesting or useful to one user is not necessarily interesting to another user. Yet another problem is that newly submitted information may not get enough exposure for user interaction and thus information that would have been considered very interesting by many users is not identified when a user seeks information.

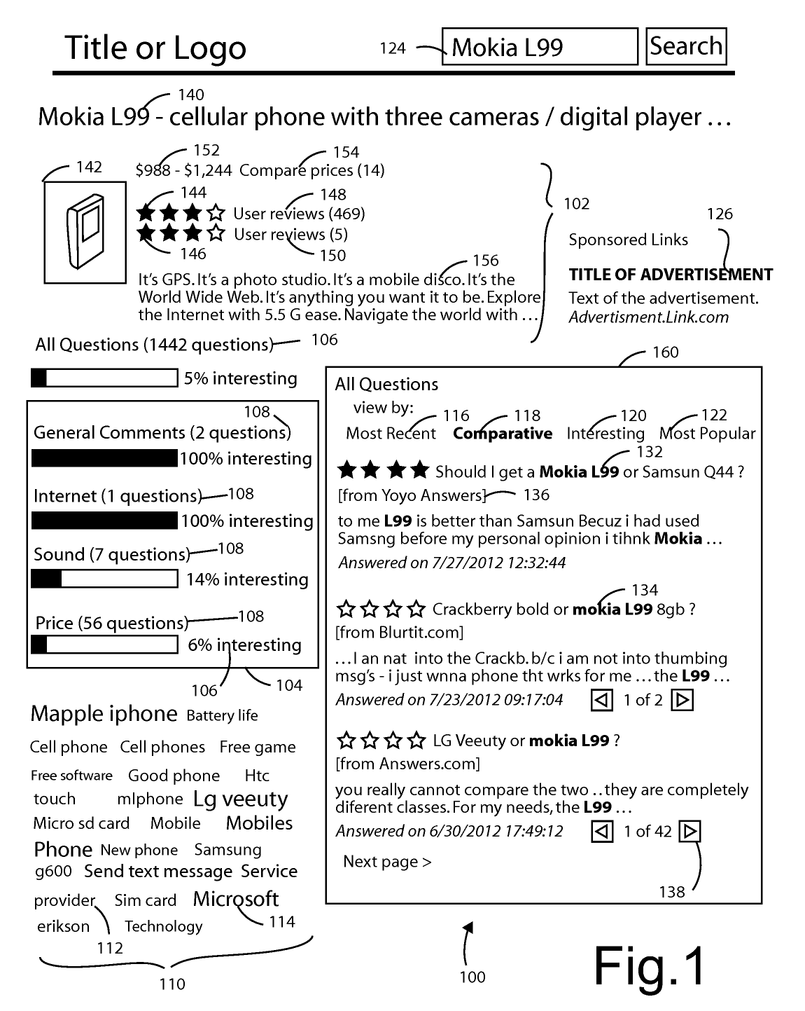

As described herein, in a particular illustrative implementation, instead of a conventional search result, a user receives an enhanced and aggregated search result upon entering a query. The result 100 of such illustrative query is shown in FIG. 1 using “Mokia L99,” an exemplary product.

Exemplary User Interface and Search Results

With reference to FIG. 1, a product summary 102 is provided to a user as part of the result 100. Such a summary 102 includes by way of example, without limitation, a title 140, a picture 142, a range of prices 152 at which the product is being offered for sale, a link to a list of sites containing prices 154, a composite average of ratings made by users 144, a link to a list of Web pages of user reviews 148, a composite average of ratings made by experts or commercial entities 146, a link to a list of Web pages of expert or commercial reviews 150, and an exemplary description of the product 156.

In one implementation, a product feature summary 104 is also provided to a user. This product feature summary 104 includes, by way of example, an overall summary of questions from community sites, some of which are flagged or tagged by users as “interesting” 106 and questions grouped according to product feature 108. For example, in FIG. 1, about five percent of 1442 questions have been marked as “interesting.” In one implementation, questions flagged as “interesting” also include those questions which have programmatically been predicted as likely to be flagged as interesting according to a method described in more detail below. If a user desires more information about “all questions,” the “all questions” is presented as a link leading to a Web page which includes a listing of all questions, preferably where the questions tagged as “interesting” by users are presented first, grouped together, or otherwise set off from the others.

Product features 108 may be generated by users, automatically generated by a computer process, or identified by some other method or means. These product features 108 may be presented as links to respective product feature Web pages which each contain listing of questions addressed to a single feature or group of related features. For example, in FIG. 1, a user is presented with a link to “sound” as a feature of the Mokia L99 cellular telephone. If a user selects the link to sound, questions addressing sound of the Mokia L99 would be listed on a separate Web page where one of the seven questions would be identified as “interesting” (about 14 percent of the seven questions as shown in FIG. 1).

Product feature Web pages preferably list questions marked as “interesting” ahead of, or differently from, other questions addressing the same product feature. A user would then be directed in a hierarchal fashion to specific product features and then to questions or answers or both questions and answers that have been marked by community site users as “interesting” or programmatically identified as likely to be “interesting.” Another designation other than “interesting” may be used and correlated or combined with those items flagged as “interesting.”

In the lower left portion of FIG. 1, a user is also presented with a tag cloud 110 or listing of keywords or “hot topics” found in the 1442 indexed questions. The size or presentation of each keyword or phrase is in proportion to its relative frequency in the set of indexed questions. For example, the word “provider” 112 is smaller than the word “Microsoft” 114 because the word “Microsoft” 114 appears more frequently then provider 112 as to those results which pertain to “Mokia L99.” The number and sizes of words and phrases in the tag cloud vary depending on the set of indexed questions.

With reference to FIG. 1, a sample of questions from the set of indexed questions is presented in a questions listing section 160. Questions may be presented in a variety of ways in this section including most recent 116, comparative 118, interesting 120 and most popular 122. In one implementation, a user is presented with a link for accessing information that is sorted in one of these ways. A set of sample comparative questions 118 is shown in FIG. 1; the word “comparative” 118 is bolded to indicate this type of question. Each question in the comparative listing of questions addresses two or more products of the same type as that identified by the query or search terms. For example, the first sample question addresses “Mokia L99” 132 and “Samsun Q44” cellular telephone telephones. Questions, answers and other types of information may be identified and to a user interface or other destination in response to selecting a comparative 118 option.

In one implementation, a summary of information about each question is presented in the questions listing section 160. For example, such a question summary includes a user rating 130 for a particular question, a bolding of a search term in the question 132 or in an answer 134 to a question. The site from which the question appears 136 is also shown. A short summary of each answer and links or other navigation to see other answers 138 to a particular question are also provided. In FIG. 1, three comparative questions are shown. However, any number of questions may be shown on a single page of a user interface.

In summary as to the user interface 100, a user is simultaneously presented with a variety of features with which to check product details, compare prices provided by a plurality of sites, and gain access to opinions from many other users from one or more sites having questions or from users who have provided answers to questions about a particular product.

Illustrative Network Topology

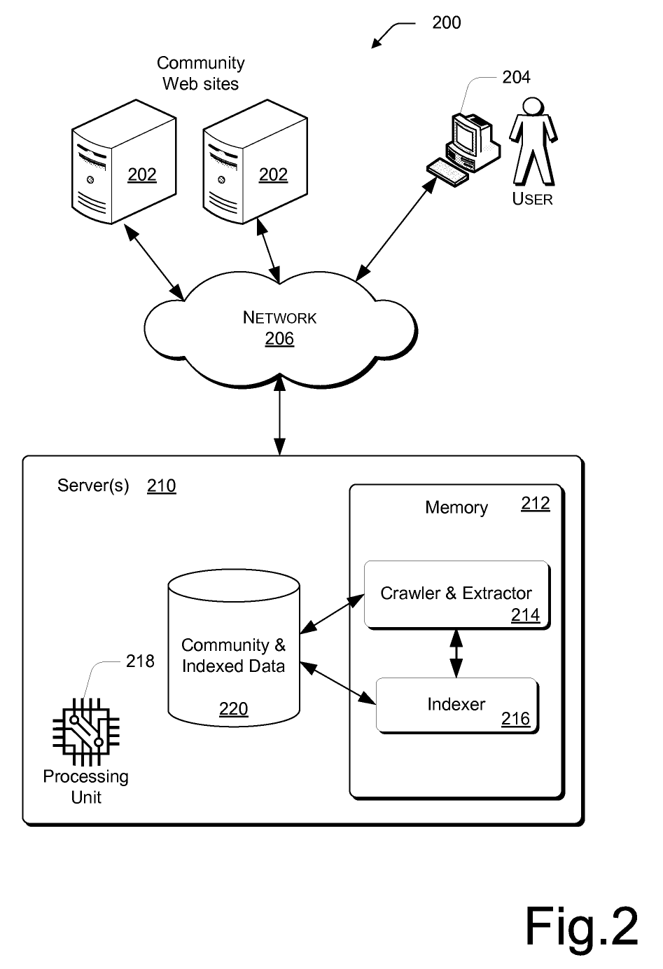

FIG. 2 shows an exemplary network topology 200 of one implementation of an improved product and service search described herein. A single server 210 is shown, but many servers may be used. The server 210 houses memory 212 on which operates a crawler and extractor application 214 and an indexer application 216. The crawler and extractor application 214 interoperates with the indexer application 216. The crawler and extractor application 214 and indexer application 216 acquire, read and store data in one or more databases. FIG. 2 shows a single database 220 for convenience. This database receives data from at least a plurality of community sites and community QnA sites 202, as obtained by the crawler and extractor application 214, and from the indexer application 216. A processing unit 218 is shown and represents one or more processors as part of the one or more servers 210. The server 210 connects to community sites 202 and to user machines 204 through a network 206 such as the Internet.

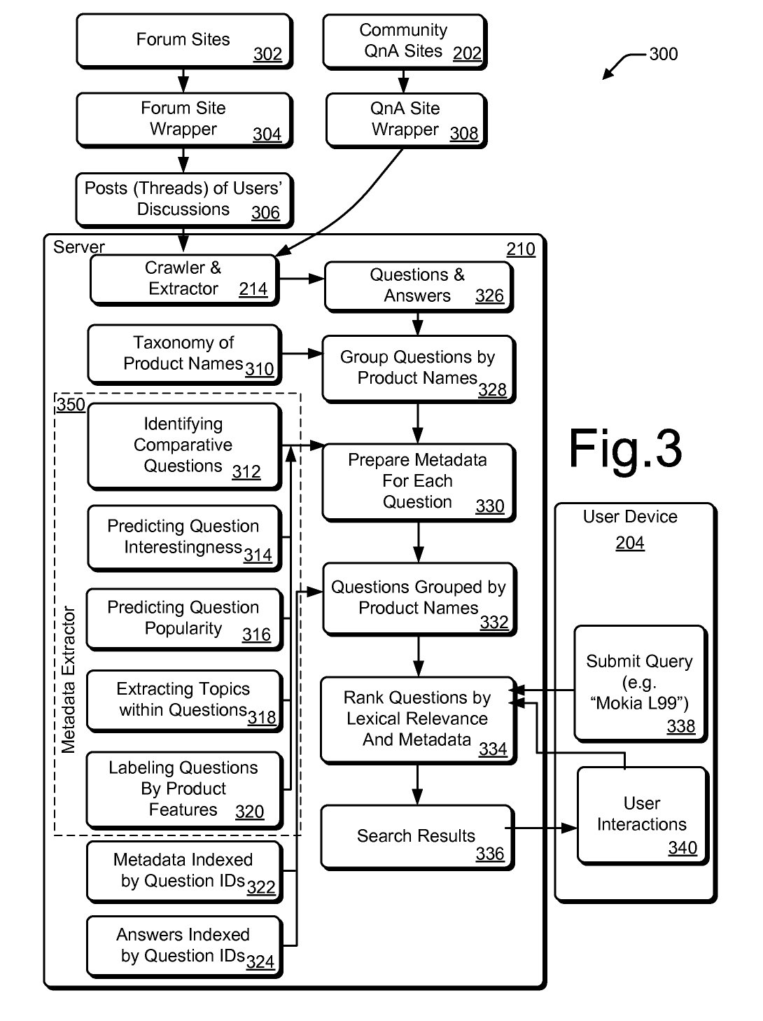

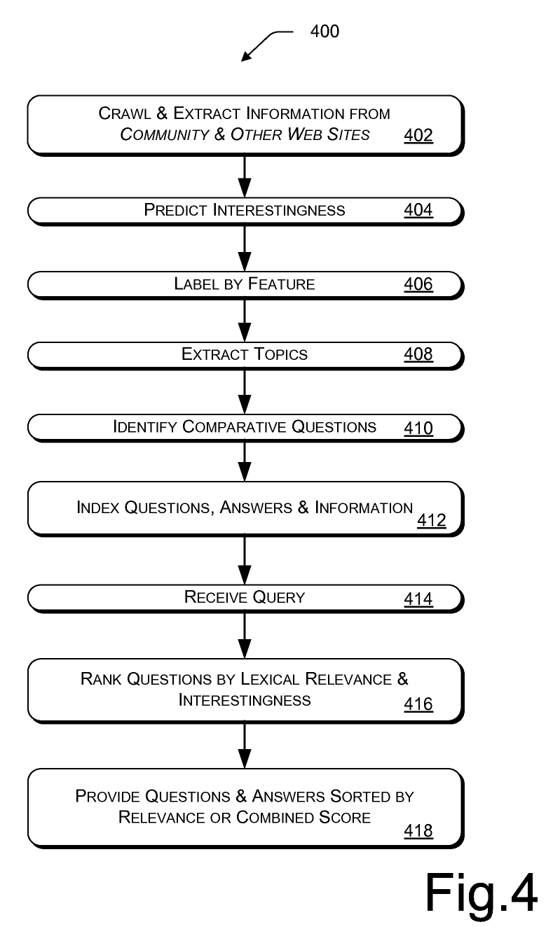

An exemplary implementation of a process to generate the user interface shown in FIG. 1 is shown in FIG. 3 and FIG. 4.

With reference to FIG. 3, one implementation of the process involves crawling and extracting information from community sites 202 and other sites including forum sites 302. Crawling and extracting are done by a crawler and extractor appliance, application or process 214 operating on one or more servers 210. For convenience, a single server is shown in FIG. 3. Crawling and extracting also takes information from forum site wrappers 304 and posts or threads of users' discussions 306 of forum sites 302. The crawling and extracting further takes information from community site wrappers 308 of community sites 202. Questions and answers 326 are taken from the extracted information.

Using a taxonomy of product names 310, questions (and answers) are grouped by product names 328. Metadata is prepared for each question (and answer) 330 from the extracted information. A metadata extractor 350 prepares such metadata through several functions. The metadata extractor 350 identifies comparative questions 312, predicts question “interestingness” 314 (as explained more fully below), predicts question popularity 316, extracts topics within questions 318, and labels questions by product feature 320.

Metadata is then indexed by question ID 322 and answers are indexed by question ID 324. Using the metadata, questions are grouped by product names 332 and questions are ranked by lexical relevance and using metadata 334.

Predicting question interestingness 314 includes flagging a question or other information as “interesting” when it has not been tagged as “interesting” or with some other user-generated label. Indexing also comprises labeling questions by feature 308 such as by product feature. While question or questions are referenced, the process described herein equally applies to answers to questions and to all varieties of information.

When a search for information about a product or service is desired, a query is submitted 338 through a user device 204. For example, a user submits a query for a “Mokia L99” in search of information about a particular cellular telephone. In response, the server 210 ranks questions, answers and other information by lexical relevance and by using metadata 334 and then generates search results 336 which are then delivered to the user device 204 or other destination. In one implementation, questions are sorted by a relevance score. A user can then interact 340 with the search results which may involve a re-ranking of questions 334.

FIG. 4 shows one implementation of a method to provide questions, answers and other product or service information sorted by relevance or other means. Community and other sites are crawled and certain information is extracted therefrom 402. If any questions (or answers or other information) have not been tagged as interesting, a prediction 404 is done to identify which of these questions would likely have been tagged as interesting. Prediction is done by determining the number of answers provided in response to a question, similarity to other questions or answers that were tagged as interesting, or by other method such as one described herein.

With reference to FIG. 4, questions, answers and other information are indexed, labeled or both indexed and labeled by feature 406. Topics about products or services are extracted 408 from the information extracted from the community and other sites. Comparative questions, answers and other information are identified 410. Questions, answers and other information are indexed 412. In one implementation, these actions or steps are performed prior to receiving a query 414. Indexing may use a relevance value to rank query results.

Next, a query may be entered by a user or may be received programmatically from any source. Based on the query, questions and other information are ranked by lexical relevance or interestingness, or relevance and interestingness 416. Then, questions, answers and other information are provided in a sorted or parsed format. In a preferred implementation, such information is provided sorted by relevance or a combined score 418.

In one implementation, through a user interface, after indexing and ranking are completed, a user is able to browse relevant questions, answers and other information addressing a particular product or service sorted by feature. Questions can also be browsed by topic since questions that address the same or similar topic are grouped together so as to provide a user-friendly and user-accessible interface. Further, search results from question and answer community sites and other types of sites are sorted and grouped by similar comparative questions. Product search is enhanced by providing an improved search of questions, answers and other information from community sites. The new search can save effort by users in browsing or searching community sites when users conduct a survey on certain products.

An improved search of questions and answers helps users not only to make decisions when users want to purchase a product or service but also to get instructions after users have already purchased a product or service. Further implementation details for one embodiment are now presented.

Product or Service Features

Each type of product or service is associated with a respective set of features. For example, for digital cameras, product features are zoom, picture quality, size, and price. Other features can be added at any time (or dynamically) and the indexing and other processing can then be re-performed so as to incorporate any newly added feature. Features can be generated by one or more users, user community, or programmatically through one or more computer algorithms and processing.

In one implementation, a feature indexing algorithm is implemented as part of a server operating crawling and indexing of community sites. The feature indexing algorithm uses an algorithm similar to an opinion indexing algorithm. This feature indexing algorithm is used to identify the features for each product or type of product from gathered data and metadata. Features are identified by using probability and identifying nouns and other parts of speech used in questions and answers submitted to community sites and, through probability, identifying the relationships between these parts of speech and the corresponding products or services.

In particular, when provided with sentences from community sites, the feature algorithm or system identifies possible sequences of parts of speech of the sentence that are commonly used to express a feature and the probability that the sequence is the correct sequence for the sentence. For each sequence, the feature identifying system then retrieves a probability derived from training data that the sequence contains a word that expresses a feature. The feature identification system then retrieves a probability from the training data that the feature words of the sentence are used to express a feature. The feature identification system then combines the probabilities to generate an overall probability that a particular sentence with that sequence expresses a feature. Potential features are then identified. Potential features across a plurality of products of a given category of product are then gathered and compared. A set of features is then identified and used. A restricted set if features may be selected by ranking based on a probability score.

In another embodiment, product or service features are determined using two kids of evidence within the gathered data and metadata. One is “surface string” evidence, and the other is “contextual evidence.” An edit distance can be used t compare the similarity between the surface strings of two product feature mentions in the text of questions and answers. Contextual similarity is used to reflect the semantic similarity between two identifiable product features. Surface string evidence or contextual evidence are used to determine the equivalence of a product or service feature in different forms (e.g. battery life and power).

When using contextual similarity, all questions and answers are split into sentences. For each mention of a product feature, the feature “mention,” or term which may be a product feature, is taken as a query and search for all relevant sentences. Then, a vector is constructed for the product feature mention by taking each unique term in the relevant sentences as a dimension of the vector. The cosine similarity between two vectors of product feature mentions can then be present to measure the contextual similarity between the two feature mentions.

Product or Service Topics

Usually, a topic around which users ask questions cannot be predicted or fall within a fixed set of topics for a product or service. While some user questions may be about features, most questions are not. For example, a user may submit “How do I add songs to my Zoon music player?” Thus, the process described herein provides users with a mechanism to browse questions around topics that are automatically extracted from a corpus of questions. To extract the topics automatically, questions are grouped around types of question, and then sequential pattern mining and part-of-speech (POS) tags-based filtering are applied to each group of questions.

POS tagging is also called grammatical tagging or word-category disambiguation. POS tagging is the process of marking up or finding words in a text as corresponding to a particular part of speech. The process is based on both its definition as well as its context—i.e., relationship with adjacent and related words in a phrase, sentence, or paragraph. A simplified form of POS tagging is commonly taught to school-age children, in the identification of words as nouns, verbs, adjectives and adverbs. Once performed by hand, POS tagging is now done in the context of computational linguistics, using algorithms which associate discrete terms, as well as hidden parts of speech, in accordance with a set of descriptive tags. Questions, answers and other information extracted from sites are treated in this manner.

Comparative Questions

Sometimes, users not only care about the product or service that they want to purchase, but also want to compare two or more products or services. As shown in FIG. 1, comparative questions are found and presented on a user interface. Further, such batch of questions can be filtered or sorted according to “interestingness” making it easier for a user to find desired or usable information.

User Labeling

Some sites allow users to label, tag or vote certain questions, answers or other information as “interesting.” Other labels are possible. Such labels express whether or not users are interested in certain questions or whether users find such questions valuable. Another example is giving a vote of a thumb up or a thumb down on a product or service. The process described herein accounts for votes by users. These votes are not only presented in the search results but are also used as part of a static ranking of search results. For those questions without votes, a model programmatically predicts “interestingness” where interestingness is a measure evaluating whether or not a question is likely to be considered interesting by users in general.

In one particular implementation, “interestingness” is defined as a quadruple (u, x, v, t) such that a user u (is an element of all users U) provides a vote v (interesting or not) for a question x which is posted at a specific time t (within R+). It is noted that v is contained within the set {1, 0} where 1 means that a user provides an “interesting” vote and 0 denotes no vote given. The set of questions with a positive “interestingness” label can be expressed as Q+={x: (u, x, v, t), v=1}.

In this implementation, such a designation of “interesting” is a user-dependent property such that different users may have different preferences as to whether a question is interesting. It is assumed for purposes of this implementation that there is a commonality of “interestingness” over all users and this is referred to as “question interestingness.” This term is formally defined in this implementation as the likelihood that a question is considered “interesting” by most users. For any given question that is labeled as “interesting” by many users, it is probable that it is “interesting” for any individual user in U.

A preference order

x⁽¹⁾ [symbol] x⁽²⁾ (1)

exists if and only if there exists (u, x⁽¹⁾, v₁, t₁) and (u, x⁽²⁾, v₂, t₂) such that v₁>v₂, |t₁−t₂|<Δt, and Δt is contained in R+.

Questions at community sites are usually sorted by posting time when they are presented to users as a list of ranked items. That is, the latest posted question is ranked highest, and then older questions are presented in reverse chronological order. The result is that questions with close posting times tend to be viewed by a particular user within a single page which means that they have about the same chance of being seen by user and about the same chance of being labeled as “interesting” by the user. With the assumption that a user u sees x⁽¹⁾ and x⁽²⁾ at about the same time within a single page, it can lead to the result that x⁽¹⁾ can be tagged as “interesting” and x⁽²⁾ left as not “interesting” by a user. Therefore, it is relatively safe to accept that for any given user, x⁽¹⁾ is more “interesting” than x⁽²⁾.

According to Equation 1, it is possible to build a set of ordered (question) instance pairs for any given user as follows:

Sᵤ={xᵢ⁽¹⁾,xᵢ⁽²⁾,zᵢ}ᵢ₌₁^{l}^{ᵤ} (2)

where zᵢ equals 1 for x⁽¹⁾ [symbol] x⁽²⁾ and −1 otherwise, and where i runs from 1 to l number of users.

The number of sets is the size of all users U (denoted |U|). S is the union ∪Sᵤ.

The assumption is that a majority of users share a common preference about “question interestingness.”

Problem Statement

It is assumed that question x comes from an input space X which is a subset of Rⁿ, where n denotes a number of features of a product. A set of ranking functions f exists where each f is an element of all functions F. Each function f can determine the preference relations between instances as follows:

xᵢ [symbol] xⱼ if and only if f(xᵢ)>f(xⱼ) (3)

The best function f* is selected from F that respects the given set of ranked instances S. It is assumed that f is a linear function such that

f_{w}(x)= [symbol] w,x [symbol] (4)

where w denotes a vector of weights and [symbol] •,• [symbol] denotes an inner product. Combining Equation 4 and Equation 3 yields

xᵢ [symbol] xⱼ if and only if [symbol] w,xᵢ−xⱼ [symbol] >0 (5)

Note that the relation xᵢ [symbol] xⱼ between instance pairs xᵢ and xⱼ is expressed by a new vector xᵢ−xⱼ. A new vector is created from any instance pair and the relationship between the elements of the instance pair. From the given training data set S, a new training data set S′ is created that contains l (lower-case letter “L”) (=Σᵤlᵤ) labeled vectors.

S′={xᵢ⁽¹⁾−xᵢ⁽²⁾,zᵢ}ᵢ₌₁^{l}>0 (6)

Similarly, S′ᵤ is created for each user u.

S′ is taken as classification data and a classification model is constructed that assigns either a positive label z=+1 or a negative label z=−1 to any vector xᵢ⁽¹⁾−xᵢ⁽²⁾.

A weight vector w* is learned by the classification model. The weight vector w* is used to form a scoring function f_{w*} for evaluating “interestingness” of a question x.

f_{w*}(x)= [symbol] w,x [symbol] (7)

In one implementation, the Perceptron algorithm is adapted for the above presented learning problem by guiding the learned function by a majority of users. The Perceptron algorithm is a learning algorithm for linear classifiers. A particular variant of the Perceptron algorithm is used and is called the Perceptron algorithm with margins (PAM). The adaptation as disclosed herein is referred to as Perceptron algorithm for preference learning (PAPL). A pseudocode listing for PAPL is as follows.

### Listing 1

| Input: | training examples {xᵢ⁽¹⁾ − xᵢ⁽²⁾,zᵢ}ᵢ₌₁^{m}, |
|---|---|
| | training rate η is an element in R+, |
| | margin parameter τ is an element in R+ |
| 1 | w₀ = 0; t = 0; |
| 2 | repeat |
| 3 for i ← 1 to m do | |
| 4 if zᵢ [symbol] wₜ,xᵢ⁽¹⁾ − xᵢ⁽²⁾ [symbol] ≦ τ then | |
| 5 wₜ₊₁ = wₜ + ηzᵢ((xᵢ⁽¹⁾ − xᵢ⁽²⁾) ; | |
| 6 [symbol] _{bt+1} = bₜ + ηzᵢ maxⱼ \|\| xⱼ⁽¹⁾ − xⱼ⁽²⁾ \|\|²; | |
| 7 t ←t + 1; | |
| 8 end if | |
| 9 end for | |
| 10 | until no updates made within the for loop |
| 11 | return wₜ; |

In this implementation, PAPL makes two changes when compared to PAM. First, instance pairs (instead of instances) are used as input. Second, an estimation of an intercept is no longer necessary (as in line 6). The changes do not influence the convergence of the PAPL algorithm.

For each user u, Listing 1 can learn a model (denoted by weight vector wᵤ) on the basis of S′ᵤ. However, none of the users can be used for predicting “question interestingness” because such users are personal to a particular user, not to all users.

An alternative implementation is to use the model (denoted by w₀) learned on the basis of S′. The insufficiency of the model w₀ originates from an inability to avoid influences of a minority of users which diverges from the majority of users in terms of preferences about “interesting.” This influence can be mitigated and w₀ can be boosted.

Different users might provide different preference labels for a same set of instance pairs. The implementation herein uses the instance pairs from a majority of users and ignores as noise those instance pairs from a minority of users, and this process is done automatically by identifying the majority from the minority. A different weight is given to each instance of pairs where a bigger weight means the particular instance pair is more important. In this implementation, it is assumed that all instance pairs from a user u share the same weight au. The next step is to determine a weight for each user.

Every w obtained by PAPL (from Listing 1) is treated as a directional vector. Predicting a preference order between two questions xᵢ⁽¹⁾ and xᵢ⁽²⁾ is achieved by projecting xᵢ⁽¹⁾ and xᵢ⁽²⁾ onto the direction denoted by w and then sorting them on a line. Thus, the directional vector wᵤ denoting a user u agreeing with a majority should be close to the directional vector w₀ denoting the majority. Furthermore, the closer a user vector is to w₀, the more important the user data is.

Cosine similarity is used to measure how close two directional vectors are to each other. A set of user weights {αᵤ} is found as follows:

$${α}_{u} = {〈 {w}_{0} , {w}_{u} 〉}_{N} = \frac{〈 {w}_{0} , {w}_{u} 〉}{‖ {w}_{0} ‖ \cdot ‖ {w}_{u} ‖} \qquad ( 8 )$$

This implementation is termed majority-based perceptron algorithm (MBPA) and emphasizes its training on the instance pairs from a majority of users. Listing 2 provides pseudo code for one implementation of this method.

### Listing 2

| Input: | training examples {xᵢ⁽¹⁾ − xᵢ⁽²⁾,zᵢ}ᵢ₌₁^{m}, |
|---|---|
| | training rate η is an element in R+, |
| | margin parameter τ is an element in R+ |
| 1 | w₀ = 0; t = 0; |
| 2 | repeat |
| 3 for i ← 1 to m do | |
| 4 if zᵢ [symbol] wₜ,xᵢ⁽¹⁾ − xᵢ⁽²⁾ [symbol] ≦ τ then | |
| 5 wₜ₊₁ = wₜ + ηzᵢ((xᵢ⁽¹⁾ − xᵢ⁽²⁾) ; | |
| 6 [symbol] _{bt+1} = bₜ + ηzᵢ maxⱼ \|\| xⱼ⁽¹⁾ − xⱼ⁽²⁾ \|\|²; | |
| 7 t ←t + 1; | |
| 8 end if | |
| 9 end for | |
| 10 | until no updates made within the for loop |
| 11 | return wₜ; |

The subject matter described above can be implemented in hardware, or software, or in both hardware and software. Although the subject matter has been described in language specific to structural features or methodological acts, it is to be understood that the subject matter defined in the appended claims is not necessarily limited to the specific features or acts described above. Rather, the specific features and acts are disclosed as exemplary forms of implementing the claimed subject matter. For example, the methodological acts need not be performed in the order or combinations described herein, and may be performed in any combination of one or more acts.

We claim:

1. A system for sorting information extracted from one or more community sites, the system comprising:
a memory and a processor;
a crawler stored in the memory, and configured when executed on the processor, to crawl and extract information from one or more community sites; and
an indexer stored in the memory and configured, when executed on the processor, to:
identify a plurality of questions from the information, wherein each question is related to at least one product or service;
group each question by product or service into a group for each product or service identified from the plurality of questions;
label each question with one or more of a plurality of identified features of a product or service to which each question is related;
group each question into a feature group, one feature group for each identified feature, any questions which are identified as related to a particular identified feature; and
provide the questions sorted by product or service and by feature group.

2. The system of claim 1 wherein the indexer is further configured to:
identify one or more answers associated with any of the questions from the information, wherein each question is related to at least one product or service;
group each answer with its respective question;
label each answer with one or more of the plurality of identified features of a product or service to which each question is related; and
provide the answers sorted by question, by product or service, and by feature group.

3. The system of claim 1 wherein the indexer is further configured to:
extract a plurality of topics from the plurality of questions;
identify questions which are related to any of the plurality of topics;
group into a topic group, one topic group for each topic, any question which is identified as related to a particular topic of the plurality of topics; and
provide the questions related to any of the topics sorted by topic group.

4. The system of claim 2 wherein the indexer is further configured to:
identify all questions or answers which compare two or more products or two or more services as respectively comparative questions and comparative answers; and
respectively group into comparative question groups or comparative answer groups the respective comparative questions and comparative answers which compare a same two or more products or two or more services.

5. The system of claim 1 wherein the indexer is further configured to:
after identifying a plurality of questions from the information, determine for each question a lexical relevance to a subject of a search query; and
rank each question by lexical relevance.

6. The system of claim 1 wherein the indexer is further configured to:
identify any questions which have been tagged with a user-generated label as tagged questions;
identify any questions which have not been tagged with a user-generated label as untagged questions;
predict, for each untagged question, whether the untagged question would likely have been tagged and identifying each such question as a likely tagged question; and
group likely tagged questions, if any, with tagged questions, if any, into a tagged question group; and
wherein the system further comprises a server configured to:
determine for each question a lexical relevance to a subject of a search query;
rank each question by a relevance score, wherein the relevance score is a combination of lexical relevance and label;
provide the questions of the tagged question group sorted by feature, by relevance score and by label.

7. A method of ranking information related to products or services, the method comprising:
crawling one or more community sites to extract information;
identifying a plurality of portions of information related to a particular product or service from each of the one or more community sites;
labeling each portion of information with at least one of a plurality of identified features of the particular product or service;
identifying portions of information which are related to any of the plurality of identified features;
grouping into a feature group, one feature group for each identified feature, any portions of information which are identified as related to a particular identified feature; and
providing the portions of information sorted by feature group.

8. The method of claim 7 wherein the portions of information are either a question or an answer, and wherein the one or more community sites are sites that accept user generated questions and answers.

9. The method of claim 7 wherein the method further comprises:
extracting a plurality of topics from the plurality of portions of information;
identifying portions of information which are related to any of the plurality of topics;
grouping into a topic group, one topic group for each topic, any portions of information which are identified as related to a particular topic of the plurality of topics; and
providing the portions of information related to any of the topics sorted by topic group.

10. The method of claim 7 wherein the plurality of identified features is pre-selected by an administrator.

11. The method of claim 8 wherein the method further comprises:
identifying any questions or answers which compare two or more products or two or more services as respectively comparative questions and comparative answers; and
respectively grouping into comparative question groups or comparative answer groups the respective comparative questions and comparative answers which compare a same two or more products or two or more services.

12. The method of claim 7 wherein the method further comprises:
identifying all portions of information which are a question;
identifying any questions which have been tagged with a user-generated label as tagged questions;
identifying any questions which have not been tagged with a user-generated label as untagged questions;
predicting, for each untagged question, whether the untagged question would likely have been tagged and identifying each such question as a likely tagged question;
grouping likely tagged questions, if any, with tagged questions, if any, into a tagged question group; and
providing the questions of the tagged question group sorted by feature and then by label.

13. The method of claim 7 wherein the method further comprises:
determining for each portion of information a lexical relevance to a subject of a search query; and
after identifying the plurality of portions of information related to a particular product or service from each of the one or more community sites, ranking each portions of information by lexical relevance.

14. The method of claim 12 wherein the method further comprises:
determining for each portion of information a lexical relevance to a subject of a search query; and
after identifying the plurality of portions of information related to a particular product or service from each of the one or more community sites, ranking each portions of information by a relevance score, wherein the relevance score is a combination of lexical relevance and label.

15. One or more computer-readable storage media comprising computer-readable instructions that, when executed by a computing device, cause the computing device to perform a method, the method comprising:
crawling one or more community sites to extract information;
identifying a plurality of portions of information related to a particular product or service from each of the one or more community sites;
labeling each portion of information with at least one of a plurality of identified features of the particular product or service;
identifying portions of information which are related to any of the plurality of identified features;
grouping into a feature group, one feature group for each identified feature, any portions of information which are identified as related to a particular identified feature; and
providing the portions of information sorted by feature group.

16. The computer-readable storage media of claim 15 wherein the portions of information are either a question or an answer, wherein the one or more community sites are sites that accept user generated questions and answers, and wherein the plurality of identified features is generated by a feature extractor.

17. The computer-readable storage media of claim 16 wherein the method further comprises:
identifying any questions or answers which compare two or more products or two or more services as respectively comparative questions and comparative answers; and
respectively grouping into comparative question groups or comparative answer groups the respective comparative questions and comparative answers which compare a same two or more products or two or more services.

18. The computer-readable storage media of claim 15 wherein the method further comprises:
extracting a plurality of topics from the plurality of portions of information;
identifying portions of information which are related to any of the plurality of topics;
grouping into a topic group, one topic group for each topic, any portions of information which are identified as related to a particular topic of the plurality of topics; and
providing the portions of information related to any of the topics sorted by topic group.

19. The computer-readable storage media of claim 15 wherein the method further comprises:
identifying all portions of information which are a question;
determining for each question a lexical relevance to a subject of a search query;
identifying any questions which have been tagged with a user-generated label as tagged questions;
identifying any questions which have not been tagged with a user-generated label as untagged questions;
predicting, for each untagged question, whether the untagged question would likely have been tagged and identifying each such question as a likely tagged question;
grouping likely tagged questions, if any, with tagged questions, if any, into a tagged question group;
ranking each question by a relevance score, wherein the relevance score is a combination of lexical relevance and label; and
providing the questions of the tagged question group sorted by feature and then by ranking.

20. The computer-readable storage media of claim 15 wherein the method further comprises:
determining for each portion of information a lexical relevance to a subject of a search query; and
after identifying the plurality of portions of information related to a particular product or service from each of the one or more community sites, ranking each portions of information by lexical relevance.
